(19) United States
(12) Patent Application Publication
(10) Pub. No.: US 2002/0194280 A1
(43) Pub. Date: Dec. 19, 2002

(54) Electronic mail system for generating a mail message to multiple recipients with multiple attention levels

(75) Inventors: John J. Altavilla, Lagrangeville, NY (US); Alex Behfar, Ithaca, NY (US); Nickolas E. Kortesis, Poughkeepsie, NY (US); Kris V. Srikrishnan, Wappingers Falls, NY (US)

Correspondence Address: George R. Pettit, Connolly Bove Lodge & Hutz LLP, P.O. Box 19088, Washington, DC, 20036-3425, US

(73) Assignee: International Business Machines Corporation, Armonk, NY

(21) Appl. No.: 09/882,109

(22) Filed: Jun. 15, 2001

(51) Int. Cl. G06F 15/16

(52) U.S. Cl. 709/206

(57) ABSTRACT

A process and apparatus for generating a mail message for multiple recipients which identify to a respective recipient an attention level. A list of addresses for the recipient is created along with a mail message to be sent to all of the recipients. Appended to each address is a tag representing an attention level for the recipients. A text message is created for each of the recipients which includes the addresses and related tag. The text message and related tags are forwarded to the recipients. Each recipient displays on an electronic mail terminal a text message addressed to him. The attention level indication contained in the tag of the message is used to alert the recipient with an attention level assigned to the message for the recipient. The attention level may also be indicated by highlighting specific portions of the text in associating a tag with the recipient's address identifying for that recipient a portion of the text message to be highlighted.

The present invention relates to an electronic mail system which generates an electronic mail message to be sent to multiple recipients. Specifically, a system is described which permits the same message to be sent to multiple recipients with a different attention level priority attached to each recipient's message.

Present day electronic mail (e-mail) messaging capabilities find wide spread use in the personal communications field. The electronic messaging capabilities are carried out via the internet, between a host ISP and a subscriber, or through an intranet private network using such applications as LOTUS notes. Electronic mail systems are now possible using wireless communications.

One of the benefits of using electronic mail messages is that the same messages may be sent to multiple recipients. With the creation of address lists, it is possible to broadcast an electronic mail message to multiple parties with a minimum amount of user effort. The system has special significance where the identical message is sent to multiple users. However, the advantage is lost where even small changes need to be made to each note being sent to a recipient. In these instances, the user is confronted with a task that essentially requires the same effort to compose an individual message for each recipient.

In the context of office communications, electronic mail is used to notify a plurality of recipients of a specific event. In general, the recipients of these messages have various degrees of interest or action required in the message, or are to take different actions in response to the message. For instance, a message which informs a number of recipients of a specific meeting may be sent to addressees who have no interest or need to attend the meeting, along with recipients who have a high degree of interest and/or responsibility for the meeting. Current electronic messaging systems do not provide a process for indicating to an individual recipient any expected level of response to the message. Thus, the received electronic mail message received by the person responsible for the meeting is indistinguishable from the recipient who receives the mail message as a mere courtesy or FYI.

The present invention is directed to a system which is capable of indicating to individual recipients of a common message the relative attention level that person need give to the message. Thus, recipients who have a high degree of participation in a matter described in the message will be alerted to the relative importance of the message, and those who receive the message on an FYI basis and have little or no responsibility associated with the subject of the message, will understand this fact by the appearance of the message.

### SUMMARY OF INVENTION

The present invention provides for electronic mail distribution to multiple parties of an electronic mail system. In accordance with the invention, a single message may be generated for multiple recipients, and a separate attention level identifier may be embedded in the message for each recipient. When the recipient receives his respective copy of the message, an indication is made on the message of the sender's relative estimation of the attention level the recipient should give the message. Accordingly, the sender of the message may indicate to certain parties that a low attention level is needed, and for other parties the sender may indicate that the recipient should give the message a much higher attention level.

A message is composed by the sender for distribution to multiple recipients. At the time the address of a recipient is entered into the message, a tag is created which is used by the sender to identify the relative attention level expected by the recipient, and each recipient of the message receives a respective attention level indicator indicating the expected response level for the recipient.

In a first embodiment of the invention, a list of addresses is provided to the sender on a pop-up menu which are individually selected by the sender. Through another menu, the user may select an attention level to be appended in the form of a tag to the address of a given recipient selected by the sender. The tag represents the relative attention level the sender wishes the recipient to give to the mail message.

Once the addresses have been created for the message along with any respective tag indicating an attention level for the various recipients, a text message is composed which is to be sent to all recipients. The text message along with the addresses and appended tags are then forwarded through the electronic mail system to each recipient. Each recipient may thereafter display the text message with the relative attention level identified by the tag received by the recipient prominently displayed.

Still other objects and advantages of the present invention will become readily apparent by those skilled in the art from the following detailed description, wherein it is shown and described preferred embodiments of the invention, simply by way of illustration of the best mode contemplated of carrying out the invention. As will be realized the invention is capable of other and different embodiments, and its several details are capable of modifications in various obvious respects, without departing from the invention. Accordingly, the description is to be regarded as illustrative in nature and not as restrictive.

### DESCRIPTION OF THE FIGURES

FIG. 1 illustrates a conventional system for generating and receiving electronic mail over the internet.

FIG. 2 represents a mail message created in accordance with one embodiment of the invention.

FIG. 3 illustrates the generation of tags when signing different attention levels to different recipients of the electronic mail message.

FIG. 4 illustrates the message as it is displayed at one the recipient's electronic mail terminal.

FIG. 5 is a block diagram illustrating the operation of an electronic mail terminal for reading electronic mail messages.

FIG. 6 illustrates the process steps executed by the computer program running in the sender's terminal for creating the message and transmitting the message of FIG. 2.

FIG. 7 illustrates the steps executed by the recipient's electronic mail system for recovering and displaying the message of FIG. 4.

### DESCRIPTION OF THE PREFERRED EMBODIMENT

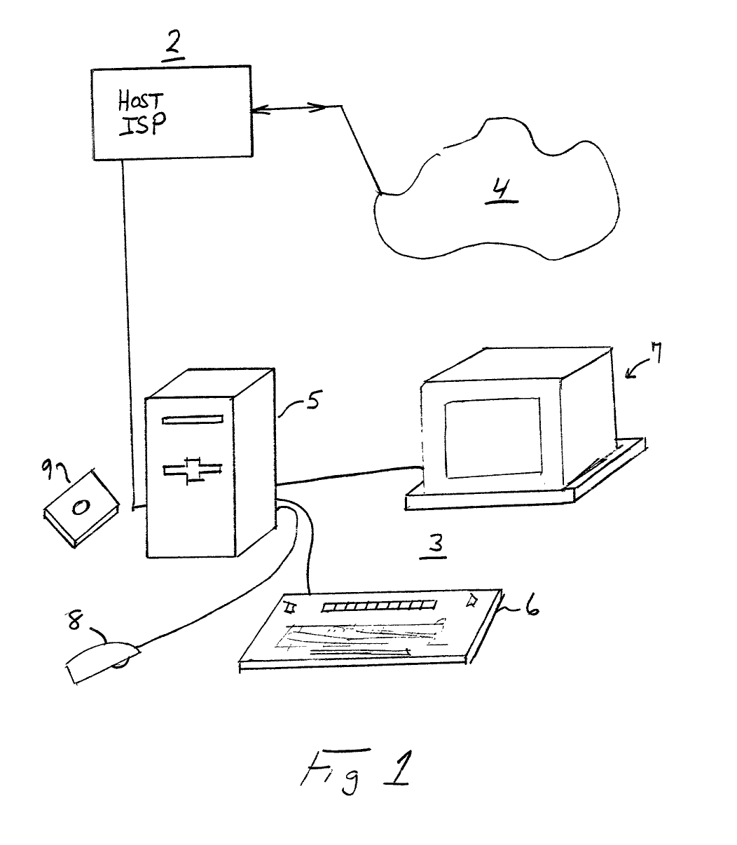

FIG. 1 illustrates a conventional electronic mail system which operates via the internet. A host internet service provider (ISP) 2 communicates with a subscriber 3 through the internet 4. The principals of the invention are equally applicable in other network configurations where electronic mail is transmitted, such as a local area network supporting electronic mail messaging.

The user's terminal 3 includes a standard computer 5, with keyboard 6, display monitor 7, and pointing device (mouse) 8. The system for implementing the preferred embodiment of the invention operates from a set of instructions which may be stored on a computer readable medium 9, such as a floppy disk, hard disk or CD ROM. The instruction set once entered in the computer will permit the user to generate mail messages in accordance with the invention, and to receive and display mail messages created in accordance with the invention.

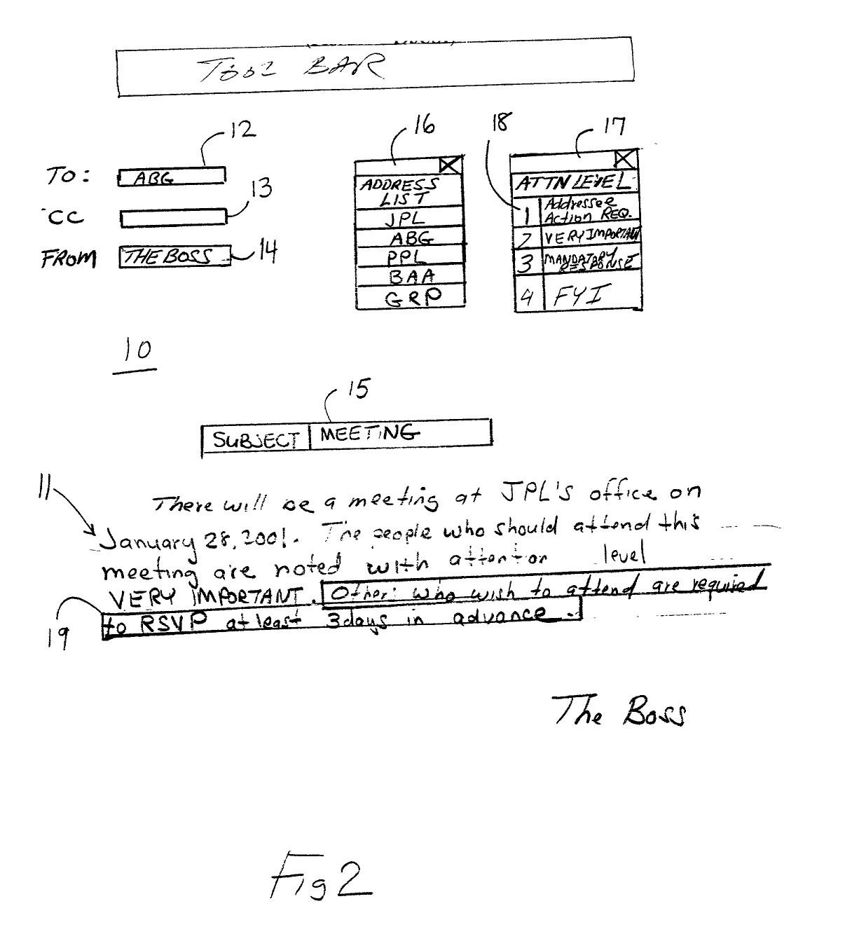

Referring now to FIG. 2, a mail message in accordance with a preferred embodiment is shown composed by the user of the electronic mail terminal 3. The displayed message is created for transfer to a plurality of users. Display fields 12, 13 and 14, in accordance with the prior art, permit a user to enter through keyboard 6 address information for the various recipients of the mail message, to copy (cc:) other addressees in field 13, and to indicate in field 14 the sender's identity. In the mail message of FIG. 2, plural recipients are to receive the same message with different attention levels attached to each message which are specific to the recipient.

The message composed in accordance with FIG. 2 is sent to addressees selected from an address list 16. The address list 16 is displayed in the form of a pop-up menu 16, and identifies each of prospective recipients for the mail message. In accordance with the preferred embodiment of the invention, a similar pop-up menu 17 is provided to prompt the user to indicate one of the various levels of attention which may be assigned to the message being delivered to a given addressee. FIG. 2 illustrates as an example four different attention levels which may be attached to a message being delivered to a specific recipient. These include the highest attention level 1, which indicates to the recipient that the sender expects action on the message. The next attention level 2 identifies the sender's interest in having the recipient treat the message as very important. The third level of attention 3 indicates the sender's desire to have a mandatory response made to the message. The lowest level of attention 4 shown in the pop-up menu 7 is a FYI level, indicating that the sender is forwarding the message for information only with no expected response or follow-up.

As the user selects each address from the address list 16 to receive the mail message, he may then assign to that address one of the attention levels in the pop-up menu 17. Using conventional graphical interface techniques, the mouse 8 may be used to select an address from the pop-up menu 16 as well as a respective attention level from pop-up menu 17 for the addressee. The user goes through the address list, selecting those addresses to receive the mail message, and at the same time selects an attention level for the selected addressee. A default attention level of FYI may be established for those addressees which the sender has not indicated an attention level.

The remaining portion of the mail message 10 includes the text of the message as well as a subject line 15. The user enters information the standard subject line 15 and prepares text similar to that shown in FIG. 2 for all recipients.

In accordance with a preferred embodiment of the invention, the sender may also highlight different portions of the text 11 for different recipients. The highlighted portion 19 is identified to a given recipient by inserting another tag through the address field of the recipient. When creating the mail message, the user may highlight a portion of the message 19, go to the address list 16, select a given addressee and once the addressee is selected, use the mouse 8 to click on the highlighted portion 19. A second tag is appended to the address identifying the highlighted portion of the mail message. When the recipient displays the received mail message, the tags are decoded by the electronic mail processor to identify a portion of the message 19 to be highlighted for that recipient. The recipient's electronic mail system highlights of the message portion identified by the decoded tag. Different portions of the text message may be highlighted for different recipients. The respective tags associated with the address identifies which highlighted portion is to be displayed by the recipient.

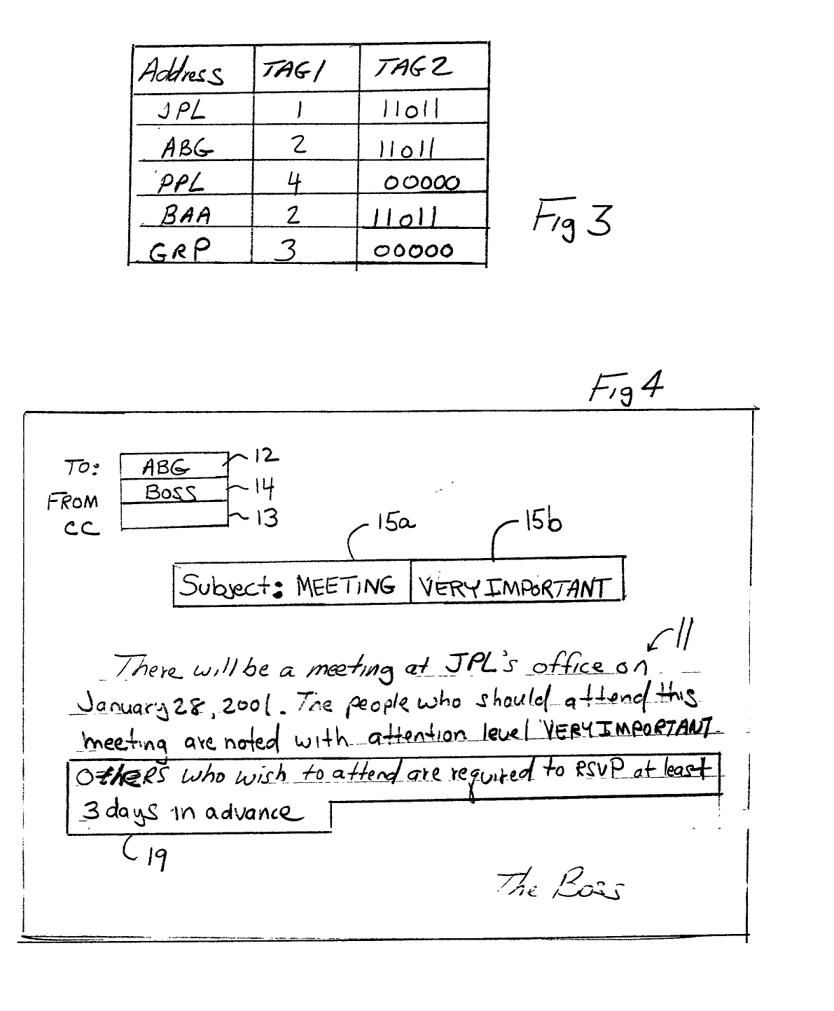

The process of creating recipient addresses to receive the mail message, and indicating the relative attention level, and any highlighted portions of the message, results in a set of tags as shown in FIG. 3 attached to each address field of each recipient to receive the message. In the example shown, addresses JPL, ABG, PPL, BAA, GRP receive messages having tags identifying different attention levels, and a tag representing portions of the mail message to be highlighted for the recipient. In the example shown, JBL receives the highest attention level (TAG1=1, “Addressee Action Required”), as he is responsible for setting up the meeting which is the subject of the message. PPL receives the message as an FYI message which will be indicated on the respective display monitors of the recipient.

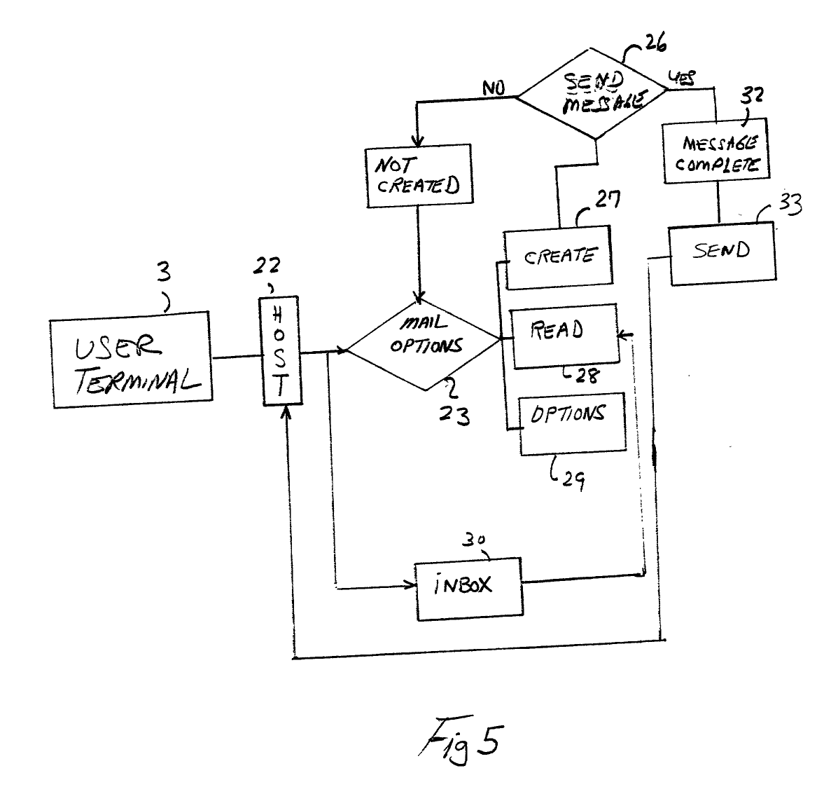

The mail message received by recipient ABG is displayed on the display monitor as shown in FIG. 4. Referring now to FIG. 4, it is clear that the recipient has the conventional address line 12, 13, and 14, and subject line 15. Subject line 15a is bifurcated into a portion containing the subject entered by the user, i.e., MEETING, and a portion 15b containing the attention level assigned by the sender. Accordingly, recipient ABG is notified that a VERY IMPORTANT attention level is expected by the sender. Address line 12 may indicate only the individual recipient (in FIG. 4, ABG), or alternatively may list all the recipients. However, the attention level portion 15b indicates the attention level assigned to the particular recipient, in this case ABG.

Further, the highlighted portion 19 of the sender's message of FIG. 2 also appears highlighted in the recipient's message of FIG. 4. As will be evident with respect to the description of the software executed by the recipient's electronic mail terminal 10, the tags received in the message, while invisible to the user, are decoded to set the attention level in portion 15B of the subject field, and to highlight the message at portion 19.

The foregoing features of the invention have been described with respect to the use of two different features for indicating the sender's expectation of an attention level for different recipients. It should be noted, that each of the features for appending an attention level to a subject line, or highlighting portions of the message for review by certain recipients, may be used in the same system, or may be individually used without the other feature.

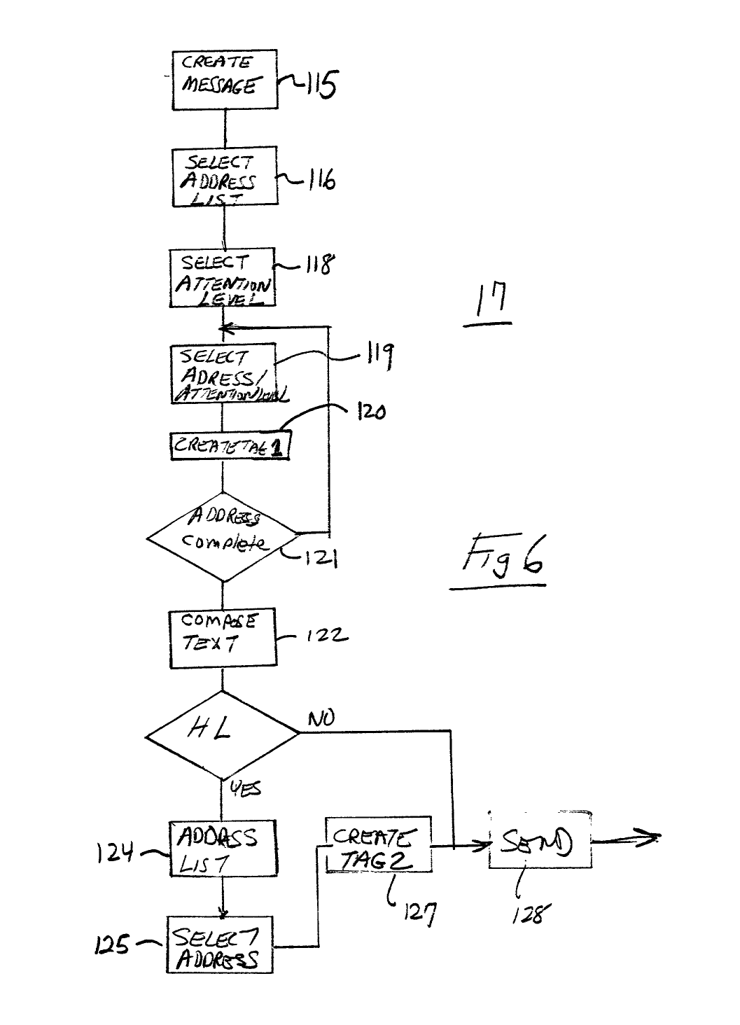

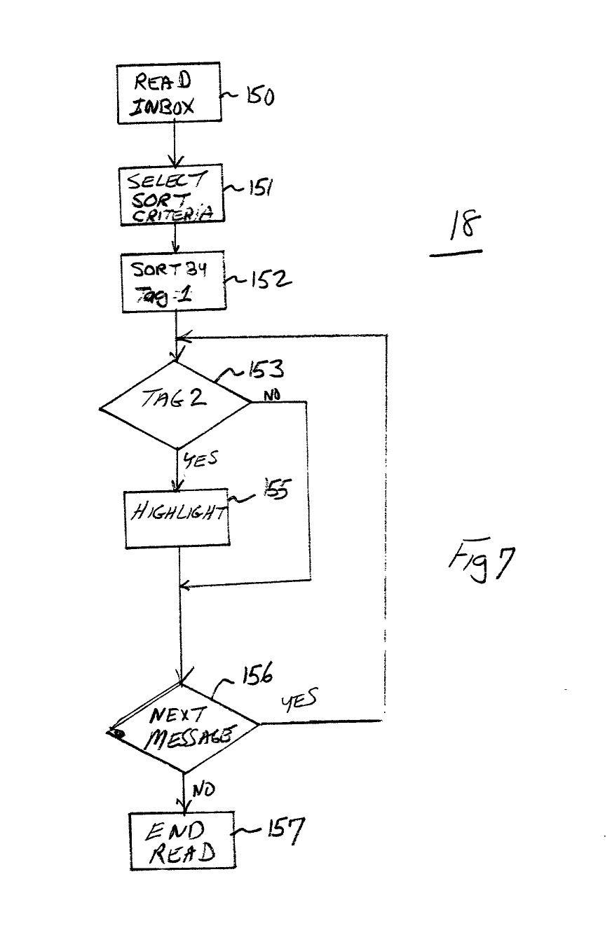

FIG. 5 illustrates the general organization of the user terminal 3 for creating and reading electronic mail messages in accordance with FIGS. 2 and 4. The user terminal 3 communicates through a host interface 22 with the ISP 2. Electronic mail software executed by the processor 5 identifies one or the other of plural options in block 23. If the user selects a process to create a message 27, the additional software steps of FIG. 6 are executed to create the message shown in FIG. 2.

If the user is reading received messages from the ISP 2, the process to read 28 to read is invoked, and the steps of FIG. 7 are executed to read messages and display messages. Additional mail options 29 are shown which, in accordance with the prior art, give the user other options with respect to use of the electronic mail system.

When the user creates a mail message such as is shown in FIG. 2, the user decides in process 26 if the message is to be sent, and if the message is complete in step 32 it is then sent in process 33 to the host ISP.

In the event that the user decides not to create the message, process control proceeds through process 24 to permit the user to select other options in process 23.

The process for creating a mail message in accordance with the format of FIG. 2 is illustrated more completely in FIG. 6. The process steps of FIG. 6 are entered as part of the electronic mail applications software executed by processor 3. When the user has indicated through the mail options 23 his intention to create a message in accordance with FIG. 2, a template is provided in step 115 in which to create the message. By selecting the appropriate tool bar selection, the pop-up menu of FIG. 2 is created, permitting the user to select with his mouse control an address from the address list 16. A second pop-up menu 17 is also displayed, and the user may select a given attention level in step 118 using the mouse controls for each address selected from the address list in step 119. A tag is created in step 120 for each address identifying a particular attention level to be assigned to the selected address. The tag forms a part of the mail message address field and is decoded by the software in the recipient's electronic mail terminal to reproduce an attention level for the received message.

Once the user has completed his address selection in step 121, the text can be composed in step 122. As part of composing the text 122, the user may decide to highlight a portion, or highlight different portions of the text message for different recipients.

Once the user enters the highlighting in the portion of the message, he may select the address list 16 again, and select the address of the recipient to receive a message having the highlighted portion in steps 124 and 125. A tag is created in step 127, and is also appended to the address field of the recipient, which will identify to the recipient's electronic mail terminal a portion of the message to be highlighted.

It should be noted that different portions of the message may be highlighted for different recipients, but subsequently highlighting and selecting an address for the newly highlighted message portion.

The recipient's electronic mail terminal 3 for reading mail messages includes an instruction set which may also be installed from a computer readable medium 9. Each electronic mail user has both an instruction set to create messages in accordance with FIG. 2, as well as to receive and display messages created by the sender as shown in FIG. 4.

FIG. 7 shows the basic instruction execution by the recipient's electronic mail terminal to receive and display the message in accordance with FIG. 3. Referring now to FIG. 7, the inbox of the user's terminal 3 is read in step 150. As a selection offered to the recipient, the user may select a sorting function in step 151 to arrange each mail message in accordance with any number of formats. As is conventional in electronic mail messaging systems, the messages may be sorted according to the date received, or some other criterion. In accordance with the present invention, the sort criterion may also be in accordance with an attention level contained in a received message. Step 152, when invoked by the user who wishes to sort received messages by their attention level, will sort the contents of the inbox by the value contained in tag 1 of the address field. The sorted messages can then be displayed, in the order of attention level, and a second tag, tag 2, identifying portions of the message to be highlighted, is decoded and highlighting is performed in the respective portions of the message under control of the mail message software in step 155. The user once having read and noted the attention level, and any highlighting in the message, may go to the next message in step 156 until all such messages contained in the inbox have been displayed and read. The user concludes the reading process by exiting the in box in step 157.

Thus, there has been described with respect to one embodiment of the invention a new electronic mail messaging system which provides multiple recipients with the same message, while having different attention levels assigned to the various recipients by the sender.

### BEST AND VARIOUS MODES FOR CARRYING OUT INVENTION

The foregoing description of the invention illustrates and describes the present invention. Additionally, the disclosure shows and describes only the preferred embodiments of the invention but, as mentioned above, it is to be understood that the invention is capable of use in various other combinations, modifications, and environments and is capable of changes or modifications within the scope of the inventive concept as expressed herein, commensurate with the above teachings and/or the skill or knowledge of the relevant art. The embodiments described hereinabove are further intended to explain best modes known of practicing the invention and to enable others skilled in the art to utilize the invention in such, or other, embodiments and with the various modifications required by the particular applications or uses of the invention. Accordingly, the description is not intended to limit the invention to the form disclosed herein. Also, it is intended that the appended claims be construed to include alternative embodiments.

What is claimed is:

1. A process for identifying an attention level in an electronic mail item being sent to multiple recipients comprising:
creating a list of addresses for said recipients;
appending to each of said addresses a tag representing an attention level for said recipients;
creating a text message for each of said recipients which includes each of said addresses and the appended tag;
forwarding said text message to said recipients; and
displaying for each recipient said text message with an attention level indication in response to the tag associated with the recipients address.

2. The process for identifying an attention level according to claim 1 further comprising:
prompting a user to append said tag to said address when said list is created.

3. The process for identifying an attention level according to claim 1 wherein said step of appending said tag to said address comprises:
selecting said attention level from a table displayed on a user's display screen; selecting an address from a table containing said address list; and
attaching a tag representing said attention level to said selected address.

4. The process for identifying an attention level according to claim 1 further comprising attaching a tag representing a default attention level when an attention level is not specified for an address.

5. The process for identifying an attention level according to claim 1 further comprising ordering each message to be displayed by a recipient according to said attention level.

6. The process for identifying an attention level according to claim 1 further comprising:
identifying a specific portion of said text message to be highlighted for a specific address; and
attaching a tag to said specific address identifying said highlighted portion of said text.

7. The process for identifying an attention level according to claim 6 wherein said step of attaching said tag to said specific address for identifying said highlighted portion of text further comprises displaying a table of said addresses following highlighting of said text; and selecting said address from said table which is to receive said tag identifying said highlighted portion.

8. A method for displaying electronic mail messages at a user's display terminal comprising:
storing said messages in a memory;
sorting said messages in accordance with a tag in each message identifying an attention level for said message; and
displaying each of said messages in an order determined from said sorting step.

9. A method for displaying electronic messages at a user's display terminal comprising:
determining from an tag inserted in a field of said message whether any portion of said message is highlighted; and
displaying said message with said portion highlighted.

10. The method according to claim 9 wherein said tag is inserted in an address field of said message.

11. An electronic mail system for generating mail messages which have an attention level comprising:
a computer terminal having a processor which executes an electronic mail program for performing the steps of:
composing a mail message for a plurality of addressees;
creating a table of addressees to receive the same mail message;
identifying in an address field of said same mail message an attention level for each addressee; and
transmitting said mail message to said addressees.

12. The electronic mail system according to claim 11 wherein said computer program performs the additional steps of:
displaying on said computer terminal a pop-up table which identifies each address to which said mail message is directed;
displaying on said computer terminal a pop-up table which identifies various attention levels which may be assigned to each addressee; and
inserting a tag identifying one of said attention levels in said address field in response to a user selection of one of said addresses and one of said attention levels.

13. An electronic mail system for receiving and displaying electronic mail messages comprising:
a computer terminal having a processor programmed to perform the steps of:
receiving electronic mail messages generated by another computer terminal;
storing said electronic mail message in a memory;
determining if said message contains a tag identifying an attention level for said message;
displaying said attention level with said message.

14. The electronic mail system according to claim 13 wherein said processor is further programmed to:
sort said messages stored in memory in accordance with said attention level determined for each message; and
display said messages in an order determined when said messages are sorted.

15. A computer readable medium for storing a program which is executed by a computer system of an electronic mail system, said program executing the steps of:
composing a mail message for a plurality of addressees;
creating a table of addressees to receive the same mail message;
identifying in an address field of said same mail message an attention level for each addressee; and
transmitting said mail message to said addressees.

16. The computer readable medium according to claim 15 wherein said computer program executes the additional steps of:
displaying on said computer terminal a pop-up table which identifies each address to which said mail message is directed;
displaying on said computer terminal a pop-up table which identifies various attention levels which may be assigned to each addressee; and
inserting a tag identifying one of said attention levels in said address field in response to a user selection of one of said addresses and one of said attention levels.

17. A computer readable medium for storing a program which is executed by a computer system of an electronic mail system, said program executing the steps of:
receiving electronic mail messages generated by another computer terminal storing said electronic mail message in a memory;
determining if said message contains a tag identifying an attention level for said message;
displaying said attention level with said message.

18. A computer readable medium for storing a program which is executed by a computer system of an electronic mail system of claim 17 wherein said program further executes the steps of:
sort said messages stored in memory in accordance with said attention level determined for each message; and
display said messages in an order determined when said messages are sorted.

19. A computer readable medium for storing a program which is executed by a computer system of an electronic mail system, said program executing the steps of:
determining from a tag inserted in a field of said message whether any portion of said message is highlighted; and
displaying said message with said portion highlighted.
